(19) United States
(12) Patent Application Publication
(10) Pub. No.: US 2026/0327075 A1
(43) Pub. Date: Oct. 22, 2026

(54) Process For Recovering Metals Present In A Phosphoric Acid Solution

(71) Applicant: Universite Mohammed VI Polytechnique, Benguerir (MA)

(72) Inventors: Rachid Benhida, Nice (FR); Mohammed Makan, El Jadida (MA); Zakaria Moutaoukil, Marrakech (MA); Abdelilah Tamin, El Jadida (MA); Hamid Mazouz, Benguerir (MA)

(73) Assignee: Universite Mohammed VI Polytechnique, Benguerir (MA)

(21) Appl. No.: 19/484,536

(22) PCT Filed: May 14, 2024
(86) PCT No.: PCT/MA2024/050016

§ 371 Date: Nov. 14, 2025

(30) Foreign Application Priority Data
May 15, 2023 (FR) FR2304880

(51) Int. Cl. C01B 25/234; B01D 15/00; B01J 20/04; B01J 20/34; C01B 25/222; C05B 1/00

(52) U.S. Cl. CPC C01B 25/234; B01D 15/00; B01J 20/045; B01J 20/3433; B01J 20/3475; C01B 25/222; C05B 1/00

(57) ABSTRACT

The invention relates to a process for upgrading metals present in a phosphoric acid solution, the process comprising the following steps: (E1) stirring a phosphoric acid solution comprising an adsorbent; (E2) treating the phosphoric acid solution using a first reagent chosen from xanthates, dithiophosphates, dithiophosphinates and mixtures thereof, so as to adsorb the metals to be upgraded on the adsorbent solid; (E3) separating the treated phosphoric acid solution and the adsorbent solid comprising the metals to be upgraded; (E4) dispersing the adsorbent solid comprising the metals to be upgraded in a solvent so as to dissolve the metals to be upgraded and regenerate the adsorbent solid; (E5) treating the solvent using a second reagent so as to precipitate the metals to be upgraded in the form of metal salts.

### TECHNICAL FIELD

The invention relates to a process for recovering metals comprised in a phosphoric acid solution.

### STATE OF THE ART

Phosphate minerals are the main source of phosphorus in fertilizers used for soil fertilization and improving agricultural yields.

Phosphate rock is usually converted into fertilizer by making phosphoric acid, which is obtained by reacting the phosphate rock with sulfuric acid. Phosphoric acid produces fertilizers containing most of the impurities originally present in the phosphate rock, including cadmium, copper, zinc, chromium, lead, arsenic, and other heavy metals.

However, regulations on the heavy metal content of phosphate fertilizers are becoming increasingly stringent. Furthermore, several consumer and environmental protection associations are campaigning to further reduce the limits for permitted heavy metal content in fertilizers.

To this end, several processes for removing heavy metals from phosphate rock or from the resulting phosphoric acid have been described to date.

Processes for removing or reducing the level of heavy metals directly in phosphate rock use flotation or high-temperature calcination techniques. These processes are very expensive and very energy-intensive and generate phosphate losses.

A process for removing or reducing heavy metals in phosphoric acid from phosphate rock processing may comprise liquid-liquid extraction of heavy metals such as cadmium, copper, and zinc. However, such an extraction technique is not suitable for processing large amounts of phosphoric acid solutions during fertilizer manufacturing processes, particularly due to separation difficulties related to the formation of emulsions, the high cost of the solvents used, and the need for their environmental management (recycling, storage, etc.).

Alternatively, the removal or reduction of heavy metals such as, for example, cadmium, copper, arsenic or zinc from phosphoric acid can involve the use of ion exchange resins. For example, cadmium can be extracted using cationic ion exchange resins. However, the affinity of cadmium is low for this type of resin, and this method generates large volumes of solutions to be concentrated, regenerated, reconditioned, etc. Cadmium can also be extracted with anionic ion exchange resins by using chemical reagents such as halides (bromide or iodide) to complex the cadmium and thus increase its affinity for said resins. However, such additives are expensive, and their addition has a negative impact on the quality of the phosphoric acid produced. Generally, the use of ion exchange resins requires pretreatment of the starting phosphoric acid in order to eliminate all suspended particles, reduce the density of the phosphoric acid to avoid clogging of the resins. These pretreatment operations are difficult to reproduce given the variability of the quality of the phosphoric acid, generate additional costs, and are difficult to implement given that industrial phosphoric acid continuously generates suspended solids during its storage.

Alternatively, cadmium can be removed from phosphoric acid by recrystallization in the presence of calcium sulfate, so that the cadmium co-crystallizes in the crystal lattice of said calcium sulfate. For this purpose, sulfuric acid is added to the phosphoric acid solution to be treated to increase the free sulfate content, which represents the excess sulfuric acid content, then raw phosphate (crushed phosphate rock) is added for the desulfation of said phosphoric acid. This operation allows to reduce the cadmium content of the phosphoric acid without adding additives other than those already present, following the manufacturing operation of said phosphoric acid, and therefore without degrading its quality. However, such a technique is specific to cadmium, and the extraction yield remains relatively low since it does not exceed 60%. Furthermore, this technique generates a significant amount of cadmium-rich solids in a non-recoverable form that must be discarded. Finally, it requires restrictive operating conditions in terms of temperature, residence time, filtration, etc., which limit its application on an industrial scale.

Chemical precipitation remains the most commonly used technology for removing metals dissolved in phosphoric acid, such as cadmium, arsenic, copper, and zinc. By adding reagents, the metals initially present in solution in their ionic forms are converted into an insoluble form. The particles formed by this reaction are removed from the solution, for example, by decantation and/or filtration.

Thus, in the presence of an adsorbent solid, dithiophosphates, dithiophosphinates or xanthates, which have a high affinity with cadmium, allow to generate, after the implementation of a solid-liquid separation, solid waste comprising the adsorbent solid contaminated by precipitates and/or complexes of metal-ligand type comprising the heavy metals to be extracted (dithiophosphates, dithiophosphinates and xanthates acting as ligands). The precipitates formed are small in size (less than 5 μm) and the complexes are soluble in phosphoric acid, so that their direct separation from said phosphoric acid is difficult and expensive. The adsorbent solid advantageously allows to collect these precipitates and/or complexes, and thus to facilitate their separation from the phosphoric acid.

However, such solid waste is not chemically stable and contact of such solid waste with water causes the heavy metals to redissolve. Their direct disposal in nature can lead to new environmental problems.

Thus, there remains a need for the provision of a process for extracting metals, particularly heavy metals, from a phosphoric acid solution that is economical and ecological and allows for the subsequent recovering of these metals.

### BRIEF DESCRIPTION OF THE INVENTION

The present invention relates to a process for recovering metals present in a phosphoric acid solution, the process comprising the following steps:
(E1) stirring a phosphoric acid solution comprising an adsorbent,
(E2) treating the phosphoric acid solution using a first reagent chosen from xanthates, dithiophosphates, dithiophosphinates and mixtures thereof, so as to adsorb the metals to be recovered on the adsorbent solid,
(E3) separating the treated phosphoric acid solution and the adsorbent solid comprising the metals to be recovered,
(E4) dispersing the adsorbent solid comprising the metals to be recovered in a solvent so as to dissolve the metals to be recovered and regenerate the adsorbent solid,
(E5) treating the solvent using a second reagent so as to precipitate the metals to be recovered in the form of metal salts;
in which the solvent is water.

Other aspects of the invention are as described below and in the claims, in particular the process may comprise at least one of the features below:
the metal salts obtained in step (E5) comprise metal sulfides, metal phosphates and/or metal hydroxides;
the adsorbent solid comprises a phosphogypsum, a zeolite, activated carbon and/or a silicate;
the phosphoric acid solution is produced by reaction between fluorophosphate calcium ores and sulfuric acid;
the phosphoric acid solution comes from a step of concentration of the phosphoric acid previously obtained by reaction of fluorophosphate calcium ores and sulfuric acid;
prior to step (E1), the phosphoric acid solution comprises phosphogypsum, the phosphogypsum content in mass percentage being less than 35%, preferably less than 10%;
the phosphoric acid solution comprises cadmium, copper, zinc, chromium, nickel, lead and/or arsenic;
the preparation step (E1) further comprises heating or cooling the phosphoric acid solution to a temperature ranging from 20° C. to 80° C.;
the preparation step (E1) further comprises the addition of a reducing agent, preferably selected from iron powder, zinc powder, iron (II) oxide, a hydrazine;
the regenerated adsorbent solid from step (E4) is reused in step (E1) of preparing the phosphoric acid solution;
which water is preferably water whose temperature is from 15° C. to 90° C., preferably from 50° C. to 80° C.;
the treatment of the phosphoric acid solution using a first reagent is carried out for a period ranging from 1 second to 30 minutes, preferably a period ranging from 5 seconds to 10 minutes;
the second reagent is selected from hydrogen sulfide, a sulfide salt and a hydrogen sulfide salt;
in step (E5), the addition of a pH regulator, preferably selected from sodium hydroxide NaOH, potassium hydroxide KOH and calcium hydroxide Ca(OH)_{2;}
during step (E5), the pH is controlled so as to successively and selectively precipitate the metal salts, each precipitated metal salt being separated from the solvent.

### BRIEF DESCRIPTION OF THE FIGURES

FIG. 1 represents an embodiment of the process for recovering metals comprised in a phosphoric acid solution according to the invention comprising the dispersion of an adsorbent solid in the phosphoric acid solution, the treatment of the phosphoric acid solution using a first reagent so as to adsorb the metals to be recovered on the adsorbent solid, the separation of the phosphoric acid solution and the adsorbent solid comprising the metals to be recovered, the dispersion of said adsorbent solid in a solvent so as to dissolve the metals to be recovered in said solvent and to regenerate the adsorbent solid, the recycling of said solid, the treatment of the solvent using a second reagent so as to precipitate the metals in an recoverable form and the recycling of the solvent. Ads*: It is understood that when the phosphoric acid solution comprises phosphogypsum resulting from the reaction between a phosphate rock and sulfuric acid and which has not been removed/separated from the phosphoric acid solution, it may not be necessary to add an adsorbent to the phosphoric acid solution.

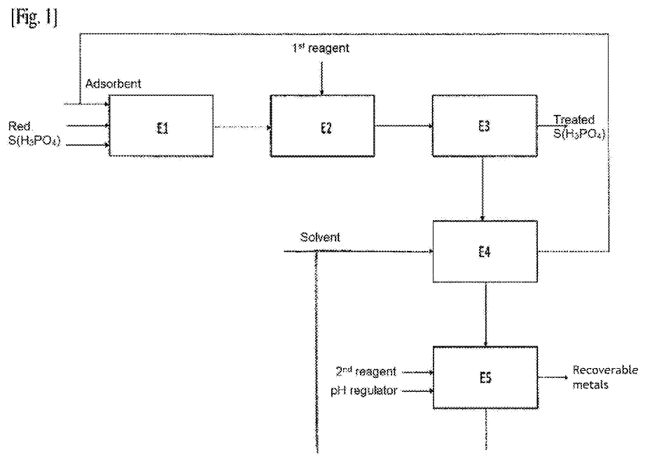

For readability reasons, the drawings are not necessarily drawn to scale.

### DETAILED DESCRIPTION OF EMBODIMENTS

The inventors have developed a process for extracting and recovering metals present in a phosphoric acid solution, preferably heavy metals such as cadmium, copper, arsenic, zinc, lead, nickel and/or chromium, by dithiophosphates, dithiophosphinates or xanthates in the presence of an adsorbent solid, typically derived from waste from the phosphate industry, which is economical and ecological.

The proposed process comprises the following steps:
(E1) stirring a phosphoric acid solution comprising an adsorbent,
(E2) treating the phosphoric acid solution using a first reagent chosen from xanthates, dithiophosphates, dithiophosphinates and mixtures thereof, so as to adsorb the metals to be recovered on the adsorbent solid,
(E3) separating the treated phosphoric acid solution and the adsorbent solid comprising the metals to be recovered,
(E4) dispersing the adsorbent solid comprising the metals to be recovered in a solvent so as to dissolve the metals to be recovered and regenerate the adsorbent solid,
(E5) treating the solvent using a second reagent so as to precipitate the metals to be recovered
in the form of metal salts,
in which the solvent is water.

The process of the present invention allows to recover metals, in particular heavy metals, in a stable and recoverable form. The fact that the process according to the invention generates the heavy metals in an recoverable form and the adsorbent solid in a reusable form makes it particularly economically advantageous for industrial applications also aiming at the implementation of a circular economy and the total absence of waste generation. 20

In order not to dispose of the adsorbent solid contaminated by heavy metal complexes and/or precipitates in the environment, the process according to the invention further provides a step of regeneration of the adsorbent solid in a solvent (E4) and a step (E5) of precipitation of the heavy metals in a stable and recoverable form (by treatment of the solvent from step (E4) with a second reagent), for example in the field of batteries or solar panels. The adsorbent solid can also be reused.

### Phosphoric Acid Solution

The phosphoric acid solution useful for implementing the process of the invention (solution to be treated) generally has a mass content of P₂O₅ greater than 0.1%, preferably ranging from 18% to 62% by weight, typically equal to 54% by weight.

The heavy metal content in the phosphoric acid solution to be treated is generally from 1 ppm to 1000 ppm. The phosphoric acid solution may comprise in particular from 1 ppm to 100 ppm of cadmium, from 1 ppm to 100 ppm of copper, from 1 ppm to 100 ppm of arsenic, from 1 ppm to 500 ppm of zinc, from 1 ppm to 100 ppm of lead, from 1 ppm to 100 ppm of nickel and/or from 1 ppm to 500 ppm of chromium.

The phosphoric acid solution to be treated preferably comes from a process for treating phosphate rock with sulfuric acid, so that the mass content of P₂O₅ in the phosphoric acid solution varies from 18% to 33% by weight. For example, such a phosphoric acid solution generally comprises from 5 ppm to 50 ppm of cadmium, from 5 ppm to 50 ppm of copper, from ppm to 50 ppm of arsenic, from 100 ppm to 300 ppm of zinc, from 1 ppm to 10 ppm of lead, from 5 ppm to 50 ppm of nickel and from 100 ppm to 300 ppm of chromium.

The phosphoric acid solution to be treated may have been previously concentrated so that it comprises from 50% to 62% by weight of P₂O₅, from 5 ppm to 100 ppm of cadmium, from 5 ppm to 100 ppm of copper, from 5 ppm to 100 ppm of arsenic, from 100 ppm to 500 ppm of zinc, from 1 ppm to 10 ppm of lead, from 5 ppm to 100 ppm of nickel and from 100 ppm to 500 ppm of chromium.

Alternatively, the phosphoric acid solution can be obtained from treating phosphate rock with other strong acids such as nitric acid, hydrochloric acid, or fluosilicic acid.

### Step (E1)

In a step (E1), the phosphoric acid solution to be treated is stirred. The solution comprises an adsorbent.

As will be explained in more detail below, the adsorbent may be added to a phosphoric acid solution or may already be present in the phosphoric acid solution. In particular, when the phosphoric acid composition comprises phosphogypsum, the addition of an additional adsorbent is not necessary.

Stirring can for example be carried out in a stirred reactor or by any other means of suspending the adsorbent solid. The phosphoric acid solution can be as described previously. The adsorbent solid allows to adsorb precipitates and/or complexes comprising the metals to be recovered formed in a treatment step (E2) and to support the precipitates and/or complexes during a solid-liquid separation step (E3). Steps (E2) and (E3) will be detailed later. The adsorbent solid may be a zeolite, activated carbon, silicate, gypsum and/or any other adsorbent.

When the phosphoric acid solution to be treated is in a phosphoric acid manufacturing plant, the adsorbent can advantageously be phosphogypsum resulting from the reaction between phosphate rock and sulfuric acid. Phosphogypsum is a very good adsorbent produced in large amounts in these plants.

It is preferable that the adsorbent solid is not too fine to facilitate the subsequent settling and/or filtration of the adsorbent solid and therefore improve the demetallization yield. Preferably, the particle size of the adsorbent solid is greater than 40 μm (particle diameter greater than 40 μm as determined by sieving). Furthermore, it is preferable that the adsorbent solid does not contain elements soluble in phosphoric acid so as not to impact the quality of the phosphoric acid. For this purpose, step (E1) may further comprise a pretreatment of the adsorbent solid before its addition to the phosphoric acid solution, for example by grinding, screening and calcination.

The rate of adsorbent solid dispersed in the phosphoric acid solution at the end of step (E1) is chosen according to the purity and the particle size of the adsorbent solid, but also according to the concentration of heavy metals in the phosphoric acid to be treated to avoid saturation of the adsorbent with heavy metals.

The adsorbent solid may be introduced/added into the phosphoric acid solution to be treated, so that at the end of step (E1), the amount of adsorbent solid in the phosphoric acid solution varies, in mass percentage, from 0.01% to 33%, preferably from 0.1% to 10% relative to the total weight of the solution. Such a solid content advantageously allows to optimize the demetallization yield (defined below), to reduce phosphoric acid losses (phosphoric acid adsorbed on the adsorbent solid at the end of step (E3) described below), to limit the consumption of the adsorbent solid (and therefore the cost of the process) and to increase the heavy metal content in the adsorbent solid at the end of step (E3).

If the phosphoric acid solution comes from a process for manufacturing phosphoric acid by treating phosphate rock with sulfuric acid, the phosphoric acid solution may already comprise phosphogypsum which will constitute all or part of the adsorbent solid used in the process according to the invention. Thus, it is not always necessary to add an adsorbent solid to the phosphoric acid solution.

Thus, the phosphoric acid solution may comprise, in mass percentages, up to 33% by weight of phosphogypsum, preferably less than 10% by weight of phosphogypsum relative to the total weight of the solution. For example, the phosphoric acid solution produced by the dihydrate process, whether before or after the solution concentration step, generally contains a phosphogypsum content comprised between 1% and 3% by weight.

When the phosphoric acid solution comprises from 1 to 33% or from 1 to 10% by weight of phosphogypsum relative to the total weight of the solution, the addition of an adsorbent solid is typically not necessary.

In certain particular embodiments of step (E1), the phosphogypsum initially present in the phosphoric acid solution constitutes all the adsorbent solid dispersed and used in the rest of the process. Such an embodiment advantageously allows to optimize the amount of solid to be managed in the following steps of the process and to reduce operating costs.

In some alternative embodiments, step (E1) comprises dispersing an additional amount of an adsorbent solid, which may or may not be phosphogypsum.

In other alternative embodiments, step (E1) comprises removing all or part of the phosphogypsum initially present in the phosphoric acid solution and adding another adsorbent solid.

In other words, the phosphoric acid solution comprising an adsorbent can:
(a) be obtained by adding an adsorbent to a phosphoric acid solution;
(b) be a phosphoric acid solution comprising phosphogypsum (solution resulting from the process of preparing phosphoric acid before filtration—the phosphogypsum is derived from the reaction between the phosphate rock and the sulfuric acid, it has not been removed/separated from the phosphoric acid solution);
(c) be a phosphoric acid solution comprising phosphogypsum (see (b)) to which an adsorbent solid is added.

It is understood that an adsorbent solid is added to a phosphoric acid solution already comprising phosphogypsum ((c)) when the phosphogypsum content in the phosphoric acid solution ((b)) is not sufficient to adsorb the precipitates and/or complexes comprising the metals to be recovered formed in a treatment step (E2) and to support the precipitates and/or complexes during a solid-liquid separation step (E3). As indicated previously, the amount of adsorbent solid in the phosphoric acid solution subjected to step (E2) typically varies, in mass percentage, from 0.01% to 33%, preferably from 0.1% to 10% relative to the total weight of the solution. This content may correspond to the phosphogypsum content of the phosphoric acid solution ((b)) or be achieved by adding an adsorbent.

Step (E1) may further comprise adjusting the temperature of the phosphoric acid solution for the remainder of the process. Preferably, the phosphoric acid solution is brought to a temperature ranging from 20° C. to 80° C. A temperature below 80° C. allows to avoid degradation of the first reagent which will be added during step (E2) described below. Furthermore, the lower the temperature (close to 20° C.) of the phosphoric acid solution, the more efficient the first reagent will be. The temperature of the phosphoric acid solution may advantageously be chosen close to room temperature, that is to say from 20° C. to 40° C., to avoid unnecessary energy expenditure related to heating or cooling the solution.

For example, in plants producing phosphoric acid from phosphate rock, the phosphoric acid solution has a temperature ranging from 30° C. to 60° C. if it is a previously concentrated phosphoric acid solution, a temperature of approximately 75° C. if the phosphoric acid solution comes directly from the dihydrate process (without a prior concentration step), or a temperature above 90° C. in the case where said solution comes instead from the hemihydrate process, so that it may be necessary to cool the phosphoric acid solution.

Optionally, step (E1) may comprise a step of clarifying the solution before adding the adsorbent solid. Such clarification is advantageously carried out when the phosphoric acid solution to be treated is cloudy, to remove organic matter and/or suspended particles. Clarification may be carried out by filtration on a support, for example on activated carbon.

### Step (E2)

In a step called treatment step (E2), the phosphoric acid solution from step (E1) is treated by adding a first reagent, the first reagent being one or more xanthates, one or more dithiophosphates and/or one or more dithiophosphinates or mixtures thereof.

Typically, the first reagent is selected from the group consisting of compounds of formula (I), compounds of formula (II) and compounds of formula (III) shown below. The counterion may be a Na⁺, K⁺, Li⁺, NH₄⁺, preferably a Na⁺.

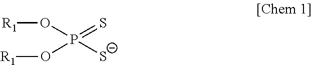

### Compound of Formula (I): Dithiophosphate (I)

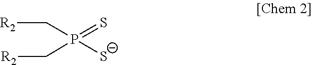

### Compound of Formula (II): Dithiophosphinate (II)

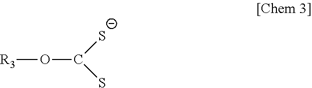

### Compound of Formula (III): Xanthate (III)

in which R₁, R₂ and R₃ are, independently, linear or branched alkyl groups comprising from 1 to 30 carbon atoms.

The first reagent reacts with the metals to be recovered in solution in the phosphoric acid solution to form precipitates and/or complexes of the metal-ligand type. For example, in the presence of copper, copper dithiophosphate, copper dithiophosphinate and/or copper dithiocarbonate are formed. Similarly, in the presence of cadmium, cadmium dithiophosphate, cadmium dithiophosphinate and/or cadmium dithiocarbonate are formed. The precipitates and/or complexes thus formed are then adsorbed by the adsorbent solid, which allows to demetallize the phosphoric acid to be treated. In a step (E3) described in more detail below, the phosphoric acid solution thus treated is separated from the adsorbent solid comprising the precipitates and/or complexes.

The demetallization yield for each metal x removed from the phosphoric acid at the end of step (E3) can be determined. The yield is expressed as a percentage and corresponds to the ratio between the amount of metal recovered after step (E3) and the amount of metal initially present in the phosphoric acid before step (E2):

$${R}_{x} ( \% ) = \frac{{C}_{x 1} {Q}_{1}}{{C}_{x 0} {Q}_{0}} \qquad [ Math 1 ]$$

with Rₓ(%) the demetallization yield of metal x, Cₓ₁ the concentration of metal x after step (E3), Cₓ₀ the concentration of metal x before step (E2), Q₁ the mass quantity of phosphoric acid after step (E3), Q₀ the mass quantity of phosphoric acid before step (E2), x being able to be copper (Cu), cadmium (Cd), zinc (Zn), arsenic (As), nickel (Ni) or chromium (Cr).

Heavy metal precipitates and/or complexes are unstable under the acidic conditions of the phosphoric acid solution (pH less than 2) and re-dissolve very quickly. Furthermore, the first reagent can degrade in various ways, for example under the effect of excessively high temperature, in secondary reactions of hydrolysis and elimination of hydrogen sulfide (H₂S). For example, a phosphoric acid solution resulting from the treatment of phosphate rock with sulfuric acid comprises between 0.5% and 3% sulfuric acid, between 0.1% and 1% iron (III) ion, between 0.1% and 2% hydrofluoric acid.

For this purpose, it is important to control the reaction time, called contact time, between the metals to be recovered and the first reagent up to the separation step (E3) described below. The optimal contact time depends on the pH and the temperature of the solution to be treated, as well as the concentration of the different oxydizing agents in the phosphoric acid solution to be treated. For a pH lower than 0 and a temperature lower than 80° C., the contact time preferably varies from 1 second to 10 minutes, more preferably from 10 seconds to 5 minutes, so as to have good diffusion of the first reagent in the phosphoric acid solution to be treated and avoid degradation of this reagent, and thus optimize the demetallization yield.

The specific consumption of the first reagent, defined as the amount of first reagent introduced per kilogram of P₂O₅ to be treated, must be sufficient to obtain the best possible demetallization yield, particularly for copper and cadmium. However, it must be as low as possible so as to reduce the final cost of the process. To obtain such a result, the specific consumption of the first reagent is preferably comprised between 0.1 g/(kg of P₂O₅) and 20 g/(kg of P₂O₅). More preferably, it is comprised between 0.1 g/(kg of P₂O₅) and 10 g/(kg of P₂O₅). The optimal specific consumption depends in particular on the chosen temperature, the contact time, and the nature of the phosphoric acid solution to be treated. In particular, a high amount of oxydizing agents and metals present in the phosphoric acid solution to be treated (for example Fe³⁺ ions), which are competitors of the metal ions to be extracted (for example Cd²⁺ ions and Cu²⁺ ions), can force an increase in the specific consumption of the first reagent. The optimal specific consumption can be determined by laboratory tests.

To improve the stability of the first reagent and the metal complexes and/or precipitates formed, a reducing agent may be added. The reducing agent may, for example, be selected from iron powder, zinc powder, iron (II) oxide and hydrazines. The reducing agent reacts with the oxydizing agents present in the phosphoric acid solution. The addition of a reducing agent therefore allows, by reducing the parasitic consumption of the first reagent, to improve the demetallization yield and/or to lower the specific consumption of the first reagent. For example, the reducing agent may reduce the Fe³⁺ ions to Fe²⁺ ions. In this way, the first reagent no longer recognizes the Fe²⁺ ions and a smaller amount of the first reagent can be introduced. The consumption of the reducing agent, equal to the amount of reducing agent introduced per kilogram of P₂O₅ to be treated, is preferably as low as possible so as not to alter the quality of the phosphoric acid to be treated and to reduce the cost of treating the phosphoric acid. It must, however, be sufficient to obtain a good demetallization yield. To obtain such a result, the consumption of the reducing agent preferably varies from 0.1 g/(kg of P₂O₅) to 20 g/(kg of P₂O₅), more preferably from 0.1 g/(kg of P₂O₅) to 10 g/(kg of P₂O₅). The consumption of the reducing agent can be optimized beforehand during tests carried out in the laboratory.

### Step (E3)

In a step (E3), the treated phosphoric acid solution is separated from the adsorbent solid comprising the metals to be recovered. Thus, the adsorbent solid constitutes a support for the filtration of the precipitates formed following the addition of the first reagent.

The separation of the treated phosphoric acid solution and the adsorbent solid comprising the metals to be recovered is carried out as quickly as possible to avoid the redissolution of heavy metals in the treated phosphoric acid solution, preferably over a period ranging from 5 seconds to 10 minutes.

The separation of the treated phosphoric acid solution and the adsorbent solid comprising the metals to be recovered can be carried out by vacuum or pressure filtration, by rotating drum or by any solid-liquid separation technique.

On the one hand, step (E3) allows to recover a treated phosphoric acid solution. In other words, the phosphoric acid solution at the end of step (E3) only comprises the remaining heavy metals following the treatment (E2) of the solution with the first reagent and the removal (E3) of the adsorbent solid, as defined by the demetallization yield of step (E2). Since the precipitation and/or complexation and adsorption reactions of step (E2) are selective for the metals to be recovered, the phosphoric acid solution retains these other constituents. In addition, the reactions have the advantage of not releasing other substances into the treated phosphoric acid solution that would change the features of the solution.

On the other hand, step (E3) allows to recover the adsorbent solid comprising the initial adsorbent, for example gypsum, and the heavy metals to be recovered in the form of precipitates and/or complexes of heavy metals, the precipitates and/or complexes having been adsorbed by the adsorbent.

The loss of phosphoric acid is generally less than 0.5% by weight when the adsorbent is phosphogypsum.

### Step (E4)

In a step (E4) called heavy metal extraction, the adsorbent solid comprising the metals to be recovered from step (E3) is dispersed in a solvent. The dispersion can be carried out for a period ranging from 1 minute to 1 hour, preferably from 5 minutes to 30 minutes. The dispersion can be carried out in a stirred reactor.

The solvent is water. The temperature of the water can range from 15° C. to 90° C., preferably from 50° C. to 80° C.

Under the effect of temperature, the adsorbent solid containing the metals to be recovered decomposes: gaseous hydrogen sulfide (H₂S) is released, the metals to be recovered dissolve in the solvent in their ionic form and the initial adsorbent solid, which remains solid, is regenerated. The mass yield obtained is greater than 99%.

In step (E4), the solvent comprising the metals to be recovered and the regenerated adsorbent solid are then separated, for example by decantation, by vacuum or pressure filtration. The separation can be carried out in a rotating drum or by any other means of solid-liquid separation.

Optionally, the adsorbent solid thus regenerated and recovered can be recycled and reintroduced as adsorbent solid in a step (E1) of the process, so that the process generates less waste and is more economically profitable since it requires a smaller amount of adsorbent solid.

### Step (E5)

The solvent comprising the metals to be recovered is reintroduced into a step called enrichment step (E5). In the enrichment step (E5), the metals to be recovered initially present in the solvent from step (E4) in their ionic form are precipitated in the form of metal salts, in particular metal sulfides, metal phosphates and/or metal hydroxides.

Metal sulfides are chemically stable forms of metals and do not re-dissolve after contact with water. Furthermore, metal sulfides are valuable forms of metals. For example, cadmium sulfide is in high demand in batteries, solar panels, and pigments. Copper sulfide is also used in the electronics, optoelectronics, and solar industries.

From a reaction point of view, the precipitation reactions of metal sulfides work well, even under the acidic conditions of the reaction medium into which the second reagent is introduced (mass yield which can be greater than 90) and therefore ensure a high recovery rate of the ionic forms of the metals to be recovered. The acidity comes from the adsorbent solid comprising the metals to be recovered dispersed wet in the solvent in step (E4), the adsorbent solid comprising, in addition to the metals to be recovered, from 20% to 30% by mass of phosphoric acid. The acidity level of the solvent in step (E5) depends on the mass ratio in which the solvent and the adsorbent solid comprising the metals to be recovered were introduced in step (E4). For example, if the solvent is water, the pH is of the order of 1 if the mixture comprises 50% by mass of solvent and 50% by mass of adsorbent solid comprising the metals to be recovered.

Furthermore, metal sulfide precipitation reactions are fast reactions, so they can be carried out over short periods of time (a few seconds), which is particularly advantageous for industrial applications.

Metal phosphates can also be precipitated by a simple increase in pH, since the solution from step E4 contains phosphoric acid, according to the following reactions:

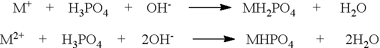

With M, metal, perhaps: Cd, Cu, Zn, As, Cr, Pb

In practice, a second reagent is introduced into the solvent comprising the metals to be recovered, the second reagent being selected so as to react with the ionic forms of the metals to be recovered and to precipitate them in the form of metal salts. The reaction of step (E5) between the second reagent and the ionic forms of the metals to be recovered can be carried out in a stirred reactor, at room temperature (that is to say which may be comprised between 20° C. and 40° C.) for a period of more than 5 minutes.

The second reagent may be hydrogen sulfide (H₂S), a sulfide salt, a hydrogen sulfide salt, and/or any other reagent capable of releasing hydrogen sulfide. For example, the second reagent may comprise sodium sulfide Na₂S or sodium hydrogen sulfide NaSH.

Alternatively, the second reagent may be sodium hydroxide NaOH, calcium hydroxide Ca(OH)₂, potassium hydroxide KOH and/or any other reagent capable of releasing hydroxide (OH) so as to produce metal hydroxides or metal phosphates depending on the pH.

The amount of second reagent introduced during step (E5) depends on the heavy metal concentration of the solvent from step (E4). For example, when the water has been mixed with the adsorbent solid comprising the metals to be recovered in mass proportions of 50:50, the amount preferably ranges from 0.1 g to 10 g per kilogram of water from step (E4). In order to optimize the consumption of the second reagent, the addition is preferably done stoichiometrically depending on the precipitation reaction.

In addition to the second reagent, during step (E5), one or more pH regulators may be introduced, for example sodium hydroxide NaOH, potassium hydroxide KOH, calcium hydroxide Ca(OH)₂ or any other reagent allowing to increase the pH of the solution.

The addition of the pH regulator allows the pH to be controlled so as to selectively precipitate the metal sulfide of interest and thus increase its purity. The separation of the solvent and the metal sulfides can then be carried out by filtration or by any other solid/liquid separation method. It is possible, by varying the pH of the solvent, to successively precipitate and filter the different metal sulfides. For example, the pH can be raised to 1, so as to selectively precipitate the copper sulfide. Then, the pH can be increased to a value of around 2 so as to precipitate the cadmium sulfide. The pH can then be further increased to a value of 3.6 to precipitate the zinc sulfide (ZnS). An increase in the pH value to 5 finally allows the iron sulfide (FeS) to precipitate.

Step E5 has a heavy metal recovery yield of 100% since the reaction conditions are very favorable and the precipitates are stable.

Optionally, the solvent from step (E5) can be recycled and reintroduced into the extraction step (E4), which advantageously allows to consume a smaller amount of clean solvent.

Thus, the possibility of recycling the adsorbent solid and the solvent and of not generating any other by-product than a treated phosphoric acid solution and heavy metals in an recoverable form makes the process interesting from an economic and ecological point of view for industrial applications.

### Examples

### Example 1: Test Series (Steps E1, E2 and E3)

The demetallization tests were carried out on an industrial phosphoric acid from the industrial complex of Jorf Lasfar in MOROCCO. The analysis of the starting acid is summarized in Table 1 below:

### [Table 1]

TABLE 1
Analysis of industrial phosphoric acid

| | P₂O₅ | | | | | | | | |
|---|---|---|---|---|---|---|---|---|---|
| Phosphoric | % by | Phosphogypsum | Cu | Cd | Zn | As | Pb | Ni | Cr |
| acid | weight | % by weight | ppm | ppm | ppm | ppm | ppm | ppm | ppm |
| | 26.43 | 0.5% | 34 | 22 | 195 | 13 | 0.45 | 25 | 105 |

An amount of 100 g of phosphoric acid was used for each test. This acid underwent steps E1, E2 and E3 by varying several parameters:
T ° C. (the processing temperature of step E1): 30° C., 50° C. or 80° C.
The adsorbent solid: Phosphogypsum or activated carbon
Adsorbent solid content: 1% to 3% by weight
The reducing agent: Iron powder or Hydrazine.
The amount of the reducing agent in g/kg P₂O₅
The first treatment reagent: dithiophosphate or Dithiophosphinate or xanthate;
Cs: The specific consumption of the first reagent in g/kg P₂O₅
Contact time.

The results obtained are presented in Tables 2, 3 and 4 below.

### [Table 2]

TABLE 2
Results obtained for the first reagent (C₄H₉)₂PS₂Na: Sodium di-isobutyl dithiophosphinate

| | | | Solid | | | | Reducing | | | | | | | | |
|---|---|---|---|---|---|---|---|---|---|---|---|---|---|---|---|
| | | | content | | Cs | | agent rate | | | | | | | | |
| | | Adsorbent | % by | | (g/kg | Reducing | (g/kg | Contact | % | Cu | Cd | Zn | As | ppm | Cr |
| | T °C | solid | weight | 1st reagent | P₂O₅) | agent | P₂O₅) | time | P₂O₅ | ppm | ppm | ppm | ppm | Ni | ppm |
| Blank 1 | 30 °C | | | — | — | — | — | — | 26.43 | 34 | 22 | 195 | 13 | 25 | 105 |
| A1-00 | 30 °C | Phos- | 1% | — | — | — | — | 30 s | 26.41 | 33 | 21.5 | 185 | 13.1 | 24.5 | 103.6 |
| | | phogypsum | | | | | | | | | | | | | |
| A1-01 | 30 °C | Phos- | 3% | — | — | — | — | 30 s | 26.38 | 34 | 21.6 | 187 | 12.8 | 24.9 | 104.1 |
| | | phogypsum | | | | | | | | | | | | | |
| A1-02 | 30 °C | — | — | (C₄H₉)₂PS₂Na | 4 | — | — | 30 s | 26.41 | 20 | 17 | 180 | 10.6 | 23.1 | 103 |
| A1-03 | 30 °C | Phos- | 1% | (C₄H₉)₂PS₂Na | 4 | — | — | 30 s | 26.49 | <0.1 | 1.5 | 120 | 3.1 | 12.3 | 80 |
| | | phogypsum | | | | | | | | | | | | | |
| A1-04 | 30 °C | Phos- | 3% | (C₄H₉)₂PS₂Na | 4 | — | — | 30 s | 26.43 | <0.1 | 0.5 | 122 | 2.1 | 10.2 | 75 |
| | | phogypsum | | | | | | | | | | | | | |
| A1-05 | 30 °C | Phos- | 1% | (C₄H₉)₂PS₂Na | 2 | — | — | 30 s | 26.39 | 4.2 | 7.6 | 140 | 6.5 | 15.3 | 92 |
| | | phogypsum | | | | | | | | | | | | | |
| A1-06 | 30 °C | Phos- | 3% | (C₄H₉)₂PS₂Na | 2 | — | — | 30 s | 26.42 | 2.1 | 5.3 | 135 | 4.3 | 13.1 | 85 |
| | | phogypsum | | | | | | | | | | | | | |
| A1-07 | 30 °C | Phos- | 1% | (C₄H₉)₂PS₂Na | 2 | Iron | 4 | 30 s | 26.43 | <0.1 | 1.3 | 110 | 2.5 | 11.6 | 82 |
| | | phogypsum | | | | Powder | | | | | | | | | |
| A1-08 | 30 °C | Phos- | 3% | (C₄H₉)₂PS₂Na | 2 | Iron | 4 | 30 s | 26.46 | <0.1 | 0.6 | 112 | 2.1 | 12.1 | 80 |
| | | phogypsum | | | | Powder | | | | | | | | | |
| A1-09 | 30 °C | Phos- | 3% | (C₄H₉)₂PS₂Na | 2 | Hydrazine | 4 | 30 s | 26.5 | 2.4 | 3.5 | 125 | 4.2 | 15.4 | 90 |
| | | phogypsum | | | | | | | | | | | | | |
| A1-10 | 50 °C | — | — | (C₄H₉)₂PS₂Na | 4 | — | — | 30 s | 26.39 | 25 | 18 | 180 | 11.1 | 18.1 | 102 |
| A1-11 | 50 °C | Phos- | 3% | (C₄H₉)₂PS₂Na | 4 | — | — | 30 s | 26.34 | <0.1 | 1.8 | 132 | 3.5 | 13.1 | 84 |
| | | phogypsum | | | | | | | | | | | | | |
| A1-12 | 50 °C | Phos- | 3% | (C₄H₉)₂PS₂Na | 2 | — | — | 30 s | 26.41 | 5.1 | 9.5 | 161 | 8.3 | 17.2 | 96 |
| | | phogypsum | | | | | | | | | | | | | |
| A1-13 | 50 °C | Phos- | 3% | (C₄H₉)₂PS₂Na | 2 | Iron | 4 | 30 s | 26.49 | <0.1 | 2.2 | 115 | 3.2 | 11.1 | 89 |
| | | phogypsum | | | | Powder | | | | | | | | | |
| A1-14 | 50 °C | Phos- | 3% | (C₄H₉)₂PS₂Na | 2 | Hydrazine | 4 | 30 s | 26.51 | 3.2 | 4.1 | 162 | 4.8 | 15.2 | 91 |
| | | phogypsum | | | | | | | | | | | | | |
| A1-15 | 80 °C | Phos- | 3% | (C₄H₉)₂PS₂Na | 4 | — | — | 30 s | 26.49 | 1.5 | 2.7 | 143 | 2.7 | 12.5 | 89 |
| | | phogypsum | | | | | | | | | | | | | |
| A1-16 | 80 °C | Phos- | 3% | (C₄H₉)₂PS₂Na | 2 | — | — | 30 s | 26.48 | 3.3 | 10.5 | 171 | 9.3 | 19.5 | 101 |
| | | phogypsum | | | | | | | | | | | | | |
| A1-17 | 80 °C | Phos- | 3% | (C₄H₉)₂PS₂Na | 2 | Iron | 4 | 30 s | 26.44 | 1.1 | 3.4 | 143 | 5.1 | 13.5 | 91 |
| | | phogypsum | | | | Powder | | | | | | | | | |
| A1-18 | 30 °C | Phos- | 3% | (C₄H₉)₂PS₂Na | 8 | — | — | 30 s | 26.42 | <0.1 | <0.1 | 108 | 0.4 | 11.1 | 81 |
| | | phogypsum | | | | | | | | | | | | | |
| A1-19 | 50 °C | Phos- | 3% | (C₄H₉)₂PS₂Na | 8 | — | — | 30 s | 26.39 | <0.1 | <0.1 | 112 | 0.6 | 10.9 | 82 |
| | | phogypsum | | | | | | | | | | | | | |
| A1-20 | 80 °C | Phos- | 3% | (C₄H₉)₂PS₂Na | 8 | — | — | 30 s | 26.44 | <0.1 | 0.6 | 123 | 1.1 | 12.4 | 85 |
| | | phogypsum | | | | | | | | | | | | | |
| A1-21 | 50 °C | Phos- | 3% | (C₄H₉)₂PS₂Na | 8 | — | — | 2 | 26.45 | 1.1 | 4.5 | 135 | 5.2 | 15.5 | 88 |
| | | phogypsum | | | | | | minutes | | | | | | | |
| A1-22 | 50 °C | Phos- | 3% | (C₄H₉)₂PS₂Na | 8 | — | — | 10 | 26.48 | 2.2 | 10.6 | 162 | 10.1 | 19.6 | 95 |
| | | phogypsum | | | | | | minutes | | | | | | | |

### [Table 3]

TABLE 3
Results obtained for the first reagent (C₄H₉O)₂PS₂Na: Sodium di-isobutyl dithiophosphate

| | | | Solid | | | | Reducing | | | | | | | | |
|---|---|---|---|---|---|---|---|---|---|---|---|---|---|---|---|
| | | | content | | Cs | Re- | agent rate | | P₂O₅ | | | | | | |
| | | Adsorbent | % by | | (g/kg | ducing | (g/kg | Contact | % by | Cu | Cd | Zn | As | Ni | Cr |
| | T °C | solid | weight | 1st reagent | P₂O₅) | agent | P₂O₅) | time | weight | ppm | ppm | ppm | ppm | ppm | ppm |
| Blank 1 | 30 °C | — | — | — | — | — | — | | 26.43 | 34 | 22 | 195 | 13 | 25 | 105 |
| A2-01 | 30 °C | — | — | (C₄H₉)₂PS₂Na | 6 | — | — | 30 s | 26.35 | 15 | 17.1 | 186 | 11.5 | 22.3 | 101 |
| A2-02 | 30 °C | Phospho- | 1% | (C₄H₉)₂PS₂Na | 6 | — | — | 30 s | 26.39 | <0.1 | 2.3 | 130 | 6.3 | 13 | 82 |
| | | gypsum | | | | | | | | | | | | | |
| A2-03 | 30 °C | Phospho- | 3% | (C₄H₉)₂PS₂Na | 6 | | | 30 s | 26.42 | <0.1 | 1.5 | 123.3 | 5.1 | 15 | 77 |
| | | gypsum | | | | | | | | | | | | | |
| A2-04 | 30 °C | Phospho- | 3% | (C₄H₉)₂PS₂Na | 3 | — | — | 30 s | 26.48 | 4.7 | 9.3 | 192.4 | 8.4 | 19 | 101 |
| | | gypsum | | | | | | | | | | | | | |
| A2-05 | 30 °C | Phospho- | 3% | (C₄H₉)₂PS₂Na | 3 | Iron | 4 | 30 s | 26.51 | 0.4 | 3.3 | 139.3 | 5.5 | 16 | 85 |
| | | gypsum | | | | Powder | | | | | | | | | |
| A2-06 | 30 °C | Phospho- | 3% | (C₄H₉)₂PS₂Na | 3 | Iron | 4 | 30 s | 26.45 | 0.2 | 2.6 | 133 | 4.1 | 14 | 82 |
| | | gypsum | | | | Powder | | | | | | | | | |
| A2-07 | 30 °C | Phospho- | 3% | (C₄H₉)₂PS₂Na | 3 | Hydrazine | 4 | 30 s | 26.41 | 2.1 | 5.5 | 158.8 | 6.2 | 17 | 96 |
| | | gypsum | | | | | | | | | | | | | |
| A2-08 | 50 °C | Phospho- | 3% | (C₄H₉)₂PS₂Na | 6 | — | — | 30 s | 26.49 | <0.1 | 3.1 | 137.5 | 4.4 | 15 | 84 |
| | | gypsum | | | | | | | | | | | | | |
| A2-09 | 50 °C | Phospho- | 3% | (C₄H₉)₂PS₂Na | 3 | — | — | 30 s | 26.52 | 5.2 | 14.5 | 190 | 8.9 | 20 | 102 |
| | | gypsum | | | | | | | | | | | | | |
| A2-10 | 50 °C | Phospho- | 3% | (C₄H₉)₂PS₂Na | 3 | Iron | 4 | 30 s | 26.49 | <0.1 | 5.2 | 156.1 | 4.8 | 15 | 95 |
| | | gypsum | | | | Powder | | | | | | | | | |
| A2-11 | 50 °C | Phospho- | 3% | (C₄H₉)₂PS₂Na | 3 | Hydrazine | 4 | 30 s | 26.43 | 2 | 6.3 | 165.8 | 6 | 17 | 100 |
| | | gypsum | | | | | | | | | | | | | |
| A2-12 | 80 °C | Phospho- | 3% | (C₄H₉)₂PS₂Na | 6 | — | — | 30 s | 26.41 | 1.1 | 2.8 | 134.8 | 4.7 | 15 | 83 |
| | | gypsum | | | | | | | | | | | | | |
| A2-13 | 80 °C | Phospho- | 3% | (C₄H₉)₂PS₂Na | 3 | — | | 30 s | 26.38 | 3.5 | 16.5 | 185 | 9.1 | 20 | 95 |
| | | gypsum | | | | | | | | | | | | | |
| A2-14 | 80 °C | Phospho- | 3% | (C₄H₉)₂PS₂Na | 3 | Iron | 4 | 30 s | 26.48 | 2.1 | 5.4 | 157.9 | 6 | 16 | 94 |
| | | gypsum | | | | Powder | | | | | | | | | |
| A2-15 | 30 °C | Phospho- | 3% | (C₄H₉)₂PS₂Na | 8 | — | — | 30 s | 26.44 | <0.1 | 0.2 | 111.8 | 0.7 | 10 | 72 |
| | | gypsum | | | | | | | | | | | | | |
| A2-16 | 50 °C | Phospho- | 3% | (C₄H₉)₂PS₂Na | 8 | — | — | 30 s | 26.45 | <0.1 | 0.8 | 117.1 | 2.2 | 12 | 73 |
| | | gypsum | | | | | | | | | | | | | |
| A2-17 | 80 °C | Phospho- | 3% | (C₄H₉)₂PS₂Na | 8 | — | — | 30 s | 26.52 | 0.4 | 1.3 | 121.5 | 4.1 | 14 | 76 |
| | | gypsum | | | | | | | | | | | | | |
| A2-18 | 80 °C | Phospho- | 3% | (C₄H₉)₂PS₂Na | 8 | — | — | 120 s | 26.49 | 0.5 | 2.5 | 132.2 | 5.2 | 16 | 82 |
| | | gypsum | | | | | | | | | | | | | |
| A2-19 | 80 °C | Phospho- | 3% | (C₄H₉)₂PS₂Na | 8 | — | — | 600 s | 26.44 | 0.8 | 8.5 | 181 | 6.3 | 17 | 102 |
| | | gypsum | | | | | | | | | | | | | |

### [Table 4]

TABLE 4
Results of heavy metal recovery yields for selected additives

| | | | Solid | | | | | | | | | | |
|---|---|---|---|---|---|---|---|---|---|---|---|---|---|
| | | | rate | | | Cs | | | | | | | |
| | | Adsorbent | % by | | | g/kg | contact | | | | | | |
| | T °C | solid | weight | 1st reagent | Type | P₂O₅ | time | R_{Cu} | R_{Cd} | R_{Zn} | R_{As} | R_{Ni} | R_{Cr} |
| Blank 1 | 50 °C | — | — | — | | — | | | | | | | |
| A3-01 | 50 °C | Phospho- | 3% | (C₂H₅O)₂PS₂Na | Dithio- | 8 | 30 s | 100% | 93% | 38% | 72% | 40% | 13% |
| | | gypsum | | | phosphate | | | | | | | | |
| A3-02 | 50 °C | Phospho- | 3% | (C₆H₉O)₂PS₂Na | Dithio- | 8 | 30 s | 100% | 58% | 33% | 53% | 48% | 43% |
| | | gypsum | | | phosphate | | | | | | | | |
| A3-03 | 50 °C | Phospho- | 3% | (C₈H₁₇O)₂PS₂Na | Dithio- | 8 | 30 s | 100% | 85% | 44% | 69% | 56% | 14% |
| | | gypsum | | | phosphate | | | | | | | | |
| A3-04 | 50 °C | Phospho- | 3% | (C₂H₅O)₂PS₂K | Dithio- | 8 | 30 s | 100% | 88% | 41% | 77% | 36% | 22% |
| | | gypsum | | | phosphate | | | | | | | | |
| A3-05 | 50 °C | Phospho- | 3% | (C₆H₁₃O)₂PS₂K | Dithio- | 8 | 30 s | 100% | 75% | 46% | 66% | 52% | 29% |
| | | gypsum | | | phosphate | | | | | | | | |
| A3-06 | 50 °C | Phospho- | 3% | (C₆H₁₃O)₂PS₂K | Dithio- | 8 | 120 s | 100% | 86% | 48% | 76% | 44% | 16% |
| | | gypsum | | | phosphate | | | | | | | | |
| A3-07 | 50 °C | Phospho- | 3% | (C₈H₁₇O)₂PS₂K | Dithio- | 8 | 30 s | 100% | 100% | 81% | 20% | 56% | 12% |
| | | gypsum | | | phosphate | | | | | | | | |
| A3-08 | 50 °C | Phospho- | 3% | (C₈H₁₇O)₂PS₂K | Dithio- | 8 | 120 s | 100% | 100% | 70% | 25% | 52% | 10% |
| | | gypsum | | | phosphate | | | | | | | | |
| A3-09 | 50 °C | Phospho- | 3% | C₄H₉OCS₂K | Xanthate | 8 | 30 s | 100% | 90% | 53% | 5% | 44% | 10% |
| | | gypsum | | | | | | | | | | | |
| A3-10 | 50 °C | Phospho- | 3% | C₄H₉OCS₂K | Xanthate | 8 | 120 s | 100% | 84% | 25% | 57% | 50% | 3% |
| | | gypsum | | | | | | | | | | | |
| A3-11 | 50 °C | Phospho- | 3% | C₅H₁₁OCS₂K | Xanthate | 8 | 30 s | 100% | 89% | 25% | 48% | 46% | 24% |
| | | gypsum | | | | | | | | | | | |
| A3-12 | 50 °C | Phospho- | 3% | C₅H₁₁OCS₂K | Xanthate | 8 | 120 s | 100% | 73% | 28% | 52% | 56% | 20% |
| | | gypsum | | | | | | | | | | | |
| A3-13 | 50 °C | Phospho- | 3% | C₆H₁₃OCS₂K | Xanthate | 8 | 30 s | 100% | 93% | 52% | 28% | 44% | 13% |
| | | gypsum | | | | | | | | | | | |
| A3-14 | 50 °C | Phospho- | 3% | C₆H₁₃OCS₂K | Xanthate | 8 | 120 s | 100% | 86% | 44% | 17% | 36% | 12% |
| | | gypsum | | | | | | | | | | | |
| A3-15 | 50 °C | Phospho- | 3% | C₈H₁₇OCS₂K | Xanthate | 8 | 30 s | 100% | 84% | 22% | 10% | 40% | 17% |
| | | gypsum | | | | | | | | | | | |
| A3-16 | 50 °C | Phospho- | 3% | C₈H₁₇OCS₂K | Xanthate | 8 | 120 s | 100% | 78% | 43% | 12% | 32% | 10% |
| | | gypsum | | | | | | | | | | | |

### Example 2: Test Series (Steps E1, E2, E3 and E4)

The heavy metal extraction tests (Steps E1, E2, E3 and E4) of the process of the invention were carried out on industrial phosphoric acid from the industrial complex of Jorf Lasfar in MOROCCO. The analysis results of the starting acid are grouped in Table 5 below:

### [Table 5]

TABLE 5
Analysis of industrial phosphoric acid

| Phosphoric | P₂O₅ % | Phosphogypsum | Cd | Cu | Zn | As | Ni | Cr |
|---|---|---|---|---|---|---|---|---|
| acid | by weight | % by weight | ppm | ppm | ppm | ppm | ppm | ppm |
| | 27.13 | 0.5% | 16.7 | 26 | 177 | 12 | 18 | 101 |

An amount of 100 kg of this acid was used for each test with the aim of producing a representative amount of heavy metals.

This acid has undergone the following operations:
1. Addition of an amount of 2.5 kg of phosphogypsum;
2. Stirring and heating to a temperature of 50° C.;
3. Addition of an amount of the first additive then filtration after 30 seconds;
4. Analysis of the phosphoric acid produced and the precipitate containing the recovered heavy metals;
5. Addition of an amount of solvent equivalent to the same weight of the precipitate from the previous operation;
6. Stirring and heating for 15 minutes at the temperature 80° C.;
7. Filtration of the mixture and analysis of the solid and liquid recovered;

The results are presented in Table 6 below.

### [Table 6]

TABLE 6
Results obtained

| | Steps of | | | P₂O₅ | | | | | | |
|---|---|---|---|---|---|---|---|---|---|---|
| First | the | | Weight | % by | Cd | Cu | Zn | As | Ni | Cr |
| reagent | Process | Product | kg | weight | ppm | ppm | ppm | ppm | ppm | ppm |
| — | — | Starting | 100 | 27.13% | 16.7 | 26.0 | 177.0 | 12 | 18 | 101.0 |
| | | Phosphoric acid | | | | | | | | |
| (C₄H₉)₂PS₂Na | Steps | Starting | 2.5 | 0.80% | 2.1 | 3.5 | 25.0 | 3.1 | 4.5 | 20.0 |
| | E1, E2 | phosphogypsum | | | | | | | | |
| | and E3 | Phosphoric acid | 99 | 27.14% | 1.1 | 0.2 | 135.0 | 5.2 | 14.3 | 82.0 |
| | | after filtration | | | | | | | | |
| | | N°1 | | | | | | | | |
| | | Solid recovered | 3.5 | 2.50% | 447.0 | 739.0 | 1254.0 | 195 | 115 | 582.0 |
| | | after Filtration | | | | | | | | |
| | | N°1 | | | | | | | | |
| | Step E4 | Amount of water | 3.5 | — | — | — | — | — | — | — |
| | | added (solvent) | | | | | | | | |
| | | Liquid solution | 4.2 | 1.30% | 369.0 | 607.0 | 1040.0 | 162 | 91 | 467.0 |
| | | after filtration | | | | | | | | |
| | | N°2 | | | | | | | | |
| | | Solid recovered | 2.8 | 1.12% | 5.1 | 13.0 | 7.8 | 3.5 | 5.1 | 25.0 |
| | | after Filtration | | | | | | | | |
| | | N°2 | | | | | | | | |
| (C₄H₉O)₂PS₂Na | Steps | Starting | 2.5 | 0.80% | 2.1 | 3.5 | 25.0 | 3.1 | 4.5 | 20.0 |
| | E1, E2 | phosphogypsum | | | | | | | | |
| | and E3 | Phosphoric acid | 99.1 | 27.21% | 1.7 | 0.4 | 145.0 | 6.3 | 15.3 | 85.0 |
| | | after filtration | | | | | | | | |
| | | N°1 | | | | | | | | |
| | | Solid recovered | 3.4 | 4.50% | 443.0 | 755.0 | 997.0 | 171 | 86 | 508.0 |
| | | after Filtration | | | | | | | | |
| | | N°1 | | | | | | | | |
| | Step E4 | Amount of water | 3.4 | — | — | — | — | — | — | — |
| | | added (solvent) | | | | | | | | |
| | | Liquid solution | 4.3 | 2.50% | 346.0 | 289.0 | 783.0 | 134 | 64 | 384.0 |
| | | after filtration | | | | | | | | |
| | | N°2 | | | | | | | | |
| | | Solid recovered | 2.5 | 1.80% | 7.1 | 15.0 | 9.7 | 2.8 | 5.9 | 30.0 |
| | | after Filtration | | | | | | | | |
| | | Nº2 | | | | | | | | |
| C₄H₉OCS₂K | Steps | Starting | 2.5 | 0.80% | 2.1 | 3.5 | 25.0 | 3.1 | 4.5 | 20.0 |
| | E1, E2 | phosphogypsum | | | | | | | | |
| | and E3 | Phosphoric acid | 98.7 | 27.17% | 2.4 | 0.8 | 143.0 | 4.1 | 12.4 | 78.0 |
| | | after filtration | | | | | | | | |
| | | N°1 | | | | | | | | |
| | | Solid recovered | 3.8 | 8.70% | 380.0 | 665.0 | 961.0 | 211 | 154 | 646.0 |
| | | after Filtration | | | | | | | | |
| | | N°1 | | | | | | | | |
| | Step E4 | Amount of water | 3.8 | — | — | — | — | — | — | — |
| | | added (solvent) | | | | | | | | |
| | | Liquid solution | 4.9 | 5.60% | 291.0 | 505.0 | 734.0 | 161 | 116 | 483.0 |
| | | after filtration | | | | | | | | |
| | | N°2 | | | | | | | | |
| | | Solid recovered | 2.7 | 2.10% | 7.2 | 17.0 | 21.0 | 6.3 | 7.3 | 32.0 |
| | | after Filtration | | | | | | | | |
| | | N°2 | | | | | | | | |

### Example 3: Test Series (Step E5)

The tests on Step E5 of the process of the invention were carried out on the liquid solutions after filtration N°2 of the test series of Example 2.

The liquid solutions, rich in heavy metals, from the tests in Example 2 were mixed and subjected to the following test:
1. Adding an amount of a pH regulator (NaOH or KOH) to control the pH of the reaction medium
2. Adding a second reagent (NaHS or Na₂S)
3. Stirring in a closed reactor for 15 minutes
4. Filtering the mixture and analysis of the solid and liquid recovered.

The results are presented in Table 7 below.

### [Table 7]

TABLE 7
Results

| | | | Amount | | P₂O₅ | | | | | | |
|---|---|---|---|---|---|---|---|---|---|---|---|
| | | Second | added in | | % by | | | | | | |
| | pH | reagent | g/Liter | Product | weight | Cd | Cu | Zn | As | Ni | Cr |
| C1-00 | <0 | — | — | Starting | 3.26% | 332.4 | 467.2 | 845.3 | 152.1 | 92.4 | 447.5 |
| | | | | solution | | ppm | ppm | ppm | ppm | ppm | ppm |
| C1-01 | 0.5 | NaHS | 20 | liquid | 3.25% | 332.6 | 1.2 | 805.2 | 0.6 | 89.4 | 446.2 |
| | | | | | | ppm | ppm | ppm | ppm | ppm | ppm |
| | | | | Solid | | 10 | 0.90% | 15 | 0.21% | 23.5 | 15 |
| | | | | | | ppm | by | ppm | by | ppm | ppm |
| | | | | | | | weight | | weight | | |
| C1-02 | 0.5 | Na₂S | 20 | liquid | 3.27% | 332.1 | 1.5 | 804 | 0.9 | 88.2 | 443 |
| | | | | | | ppm | ppm | ppm | ppm | ppm | ppm |
| | | | | Solid | | 14 | 0.92% | 26 | 0.22% | 19.3 | 13.2 |
| | | | | | | ppm | by | ppm | by | ppm | ppm |
| | | | | | | | weight | | weight | | |
| C1-03 | 1 | NaHS | 20 | liquid | 3.22% | 310.3 | — | 702.3 | — | 87 | 436 |
| | | | | | | ppm | | ppm | | ppm | ppm |
| | | | | Solid | — | 0.10% | 0.91% | 0.20% | 0.22% | 480 | 12.3 |
| | | | | | | by | by | by | by | ppm | ppm |
| | | | | | | weight | weight | weight | weight | | |
| C1-04 | 1 | Na₂S | 20 | liquid | 3.24% | 315.5 | — | 695.3 | — | 86 | 442 |
| | | | | | | ppm | | ppm | | ppm | ppm |
| | | | | Solid | — | 0.11% | 0.92% | 0.19% | 0.21% | 490 | 15.1 |
| | | | | | | by | by | by | by | ppm | ppm |
| | | | | | | weight | weight | weight | weight | | |
| C1-05 | 2 | NaHS | 20 | liquid | 3.23% | — | — | — | — | — | 439 |
| | | | | | | | | | | | ppm |
| | | | | Solid | | 0.66% | 0.91% | 0.55% | 0.22% | 0.18% | 22 ppm |
| | | | | | | by | by | by | by | by | |
| | | | | | | weight | weight | weight | weight | weight | |
| C1-06 | 2 | Na₂S | 20 | liquid | 3.24% | — | — | — | — | — | 423 |
| | | | | | | | | | | | ppm |
| | | | | Solid | | 0.65% | 0.93% | 0.58% | 0.22% | 0.17% | 27 ppm |
| | | | | | | by | by | by | by | by | |
| | | | | | | weight | weight | weight | weight | weight | |
| C1-07 | 4 | NaHS | 20 | liquid | 3.25% | — | — | — | — | — | 75 ppm |
| | | | | Solid | | 0.66% | 0.91% | 1.62% | 0.21% | 0.17% | 0.75% |
| | | | | | | by | by | by | by | by | by |
| | | | | | | weight | weight | weight | weight | weight | weight |
| C1-08 | 6 | NaHS | 20 | liquid | 3.24% | — | — | — | — | — | — |
| | | | | Solid | | 0.66% | 0.92% | 1.64% | 0.22% | 0.18% | 0.90% |
| | | | | | | by | by | by | by | by | by |
| | | | | | | weight | weight | weight | weight | weight | weight |

1. A process for recovering metals present in a phosphoric acid solution, the process comprising the following steps:
(E1) stirring a phosphoric acid solution comprising an adsorbent,
(E2) treating the phosphoric acid solution using a first reagent chosen from xanthates, dithiophosphates, dithiophosphinates and mixtures thereof, so as to adsorb the metals to be recovered on the adsorbent solid,
(E3) separating the treated phosphoric acid solution and the adsorbent solid comprising the metals to be recovered,
(E4) dispersing the adsorbent solid comprising the metals to be recovered in a solvent so as to dissolve the metals to be recovered and regenerate the adsorbent solid,
(E5) treating the solvent using a second reagent so as to precipitate the metals to be recovered in the form of metal salts, in which the solvent is water.

2. The process according to claim 1, wherein the metal salts obtained in step (E5) comprise metal sulfides, metal phosphates and/or metal hydroxides.

3. The process according to claim 1, wherein the adsorbent solid comprises a phosphogypsum, a zeolite, activated carbon and/or a silicate.

4. The process according to claim 1, wherein the phosphoric acid solution is produced by reaction between fluorophosphate calcium ores and sulfuric acid.

5. The process according to claim 1, wherein the phosphoric acid solution comprising an adsorbent is obtained by adding an adsorbent to a phosphoric acid solution.

6. The process according to claim 1, wherein the phosphoric acid solution comprising an adsorbent is a phosphoric acid solution comprising phosphogypsum resulting from the reaction between a phosphate rock and sulfuric acid and which has not been removed.

7. The process according to claim 1, wherein the phosphoric acid solution comprises cadmium, copper, zinc, chromium, nickel, lead and/or arsenic.

8. The process according to claim 1, wherein the preparation step (E1) further comprises heating or cooling the phosphoric acid solution to a temperature ranging from 20° C. to 80° C.

9. The process according to claim 1, wherein the preparation step (E1) further comprises the addition of a reducing agent, preferably selected from iron powder, zinc powder, iron (II) oxide, a hydrazine.

10. The process according to claim 1, wherein the regenerated adsorbent solid from step (E4) is reused in step (E1) of preparing the phosphoric acid solution.

11. The process according to claim 1, wherein the water is at a temperature ranging from 15° C. to 90° C., preferably from 50° C. to 80° C.

12. The process according to claim 1, wherein the treatment of the phosphoric acid solution using a first reagent is carried out for a period ranging from 1 second to 30 minutes, preferably a period ranging from 5 seconds to 10 minutes.

13. The process according to claim 1, wherein the second reagent is selected from hydrogen sulfide, a sulfide salt and a hydrogen sulfide salt.

14. The process according to claim 1, further comprising, in step (E5), the addition of a pH regulator, preferably selected from sodium hydroxide NaOH, potassium hydroxide KOH and calcium hydroxide Ca(OH)₂.

15. The process according to claim 1, wherein, during step (E5), the pH is controlled so as to successively and selectively precipitate the metal salts, each precipitated metal salt being separated from the solvent
